(19) United States
(12) Patent Application Publication
(10) Pub. No.: US 2007/0268121 A1
(43) Pub. Date: Nov. 22, 2007

(54) ON-LINE PORTAL SYSTEM AND METHOD FOR MANAGEMENT OF DEVICES AND SERVICES

(76) Inventors: Daryush Vasefi, Dana Point, CA (US); Navideh Mostajab, Dana Point, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/750,129

(22) Filed: May 17, 2007

Related U.S. Application Data
(60) Provisional application No. 60/801,572, filed on May 18, 2006.

(51) Int. Cl. G08B 29/00; G06Q 10/00; H04Q 7/38; H04N 7/18

(52) U.S. Cl. 340/506; 705/1; 455/414.1; 348/143

(57) ABSTRACT

An on-line device management system provides a common interface for managing devices using a single login to a website associated with the system over a public network. Users sign up for selected services including surveillance and provide information on associated user devices which include devices with different operational programming interfaces, and user and device information is stored by the system. The system communicates with the devices and controls the devices using the stored device information so that the devices send data to the system on a selected schedule. The system creates a customized interface for each user through which the user can monitor and manage building surveillance devices from a remote location at any time.

### RELATED APPLICATION

The present application claims the benefit of co-pending U.S. provisional patent application No. 60/801,572 filed May 18, 2006, the content of which is incorporated herein by reference in its entirety.

### BACKGROUND

1. Field of the Invention

The present invention generally relates to an on-line portal system and method for providing users with various services, and is particularly concerned with a system for providing on-line or web-based management of devices, digital services or systems associated with homes, businesses, and other such facilities.

2. Related Art

Various digital services and systems are currently provided to homeowners, businesses, and the like, such as security or surveillance systems, automation and control systems for utilities, energy management, irrigation, lighting, and the like. One problem with current systems is that the manufacturers of equipment for such systems provide software which only works with their own hardware, so that end users are locked into using hardware which works only with one manufacturer's software or with one automation system. Automation system and manufacturer software is typically based on one technology, such as Microsoft® operating systems, and this results in limited interoperability and adoption.

Currently, when a person wants to have a service such as a surveillance system installed at their home or business, they purchase the equipment from one manufacturer, which normally includes a software application. The software application is installed on a personal computer or a server and allows the owner to view, record, and manipulate the output of cameras. However, if another manufacturer comes up with a better camera having better resolution, or a less expensive camera, for example, the system owner cannot simply purchase one or more of those cameras and add them to the existing system, but is excessively encumbered by the limitations of what the manufacturer imposes by the use of their software. In many instances the owner is forced to buy a complete new system or incur excessive integration costs. This means that they end up with two systems running in parallel which do not communicate with each other. Since technology in this area and others is progressing rapidly and prices are dropping considerably in a short time frame, the inability to add components from other manufacturers to an existing system causes inconvenience to customers.

Another problem with existing automated systems such as surveillance, security, automated control of various home or business systems, and the like, is that the owner has to learn a specific software with one system and this software may be completely different if they change to a different manufacturer's system, resulting in significant re-training of staff which can be expensive. Also, individual system components are typically not monitored automatically for maintenance purposes, such as the cameras of surveillance or security systems. Thus, when a camera or recording unit becomes inoperative, the owner often does not find out until a security event has happened, when it is too late.

Another problem with existing systems is that most have PC based software, which must be installed on a workstation by the user before the user can access or manage the device.

Similar issues exist in the home automation and control industry, where the end-user is locked by any software they purchase and the devices which are compatible with that software.

Therefore, what is needed is a system and method that overcomes these significant problems found in the conventional systems as described above.

### SUMMARY

Embodiments described herein provide a web-based or on-line portal system and method for device management and user access which allows users to remotely connect to and communicate with devices providing digital services at a location such as a home or business. In some embodiments, a customized user interface for individual end users allows them to access the devices via an on-line portal or gateway.

According to one aspect, a web-based device management and user access system is provided, which comprises a user interface or log-in module which allows a user to access the system, a surveillance unit which is linked to a plurality of surveillance devices associated with users of the system, at least some of the surveillance devices having different application programming interfaces, the surveillance unit having a communication module which communicates with each surveillance device using the application programming interface of the respective surveillance device, a control module which controls operation of each linked surveillance device to send data from the surveillance device to the surveillance unit, an archiving module which receives and stores data from each of the surveillance devices to which it is linked, a management module which monitors the status of each surveillance device and provides a notification to the respective user if a monitored surveillance device is not operating correctly, and a display module which displays the output of selected surveillance devices to the user associated with the devices on request by the user, the display module having a user control module which allows the user to select between different display options including real time and archived data display.

In one embodiment, the system has a data analysis or traffic count module which analyzes data collected by traffic count or motion detector devices in ways which are controlled by the registered user associated with the devices. One way in which the analytic module may be operated is to carry out a traffic count of any object specified by a user, for example the number of people passing through one or more locations in a facility (home or business) in selected time periods. The analytic module includes a display module for displaying analyzed data in various formats, such as graphical, numerical tables, and the like. The analytic module may be used, for example, to determine the effectiveness of an advertising campaign. Effectiveness may be gauged by an increase in traffic after the campaign is introduced. The analytic module may also be linked to point of sale (POS) systems at various businesses so as to record and store sales information. This in turn may be linked to the traffic data.

In one embodiment, additional functions may be provided by the management and user access system, such as a home or business automation system which has a connection module which connects to a plurality of home or business automation modules associated with users of the system, each automation module being linked to one or more devices in a home or office selected from the group consisting of lighting, appliances, irrigation devices, locking devices, utilities, computer systems, and entertainment systems, and a user control module which allows a user logged on to the system to control operation of the automation system. The system may also include a personal assistant module which allows a user to enter information on various types of item purchased, such as date of purchase, vendor, warranty and service information, and which tracks deadlines such as warranty expiry dates and sends reminders to users in advance of such dates.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram of an on-line portal or device management and user access system according to one embodiment;

FIG. 2 is a more detailed diagram of the on-line portal system of FIG. 1;

FIG. 3 is a block diagram illustrating the central data base and application modules of the system of FIGS. 1 and 2 in more detail, with the system communicating with one user and with devices associated with the user;

FIG. 4 is a block diagram of the surveillance module of FIG. 3;

FIG. 5 is a flow diagram illustrating initial procedures for activating a new user to access and use the system;

FIG. 6 is a flow diagram illustrating a method for initializing a new user device for system communication and control;

FIG. 7 is a screen shot illustrating a customized user interface in the system of FIGS. 1 to 4;

FIG. 8 is a flow diagram illustrating a method of using the system to access surveillance devices at one or more locations;

FIG. 9 is a flow diagram illustrating a method of archiving data from user devices;

FIG. 10 is a flow diagram illustrating a method for monitoring of device function by the system;

FIG. 11 is a functional block diagram illustrating operation of a traffic counter or data analysis module of the system.

FIG. 12 is a flow diagram illustrating a traffic counting method using the module of FIG. 11;

FIG. 13 illustrates an example of a traffic count display provided by the traffic counter module of FIGS. 11 and 12;

FIG. 14 is a screen shot illustrating one example of a traffic count report;

FIG. 15 is a screen shot illustrating an alternative traffic count report;

FIG. 16 is a more detailed block diagram of the personal assistant module of FIG. 3; and

FIGS. 17 to 19 are screen shots illustrating various options provided by the personal assistant module.

### DETAILED DESCRIPTION

Certain embodiments as disclosed herein provide for systems and methods for providing on-line or web-based management of devices, services and/or systems. For example, one method as disclosed herein allows for users to monitor office or home systems such as surveillance and automation systems over an on-line portal accessible through the Internet or other public network, with the option to access other selected services through the same portal.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

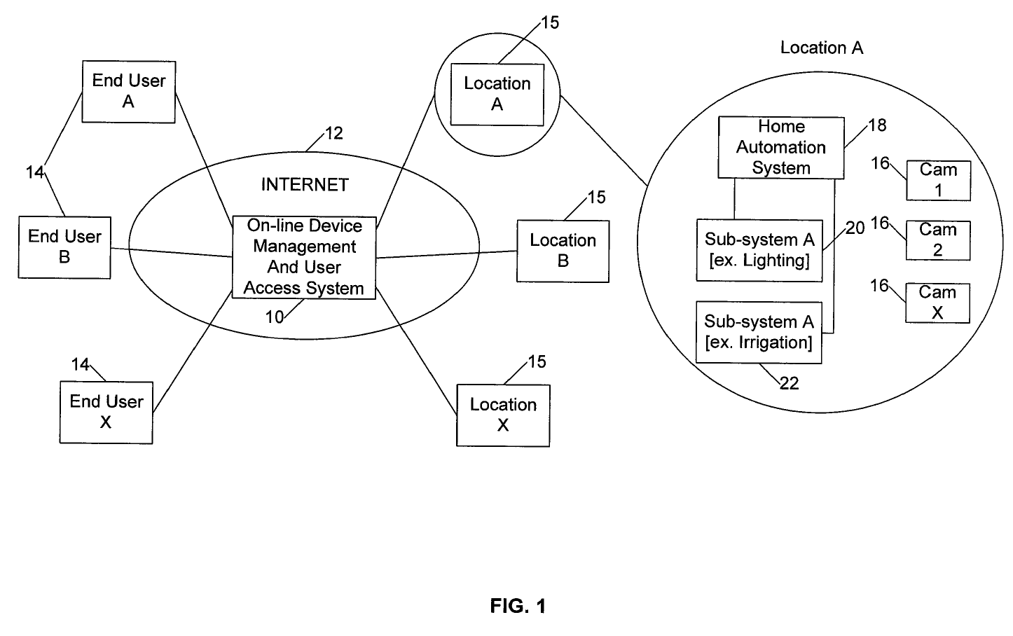

FIGS. 1 to 19 illustrate one embodiment of an on-line portal system and method which allows users to sign up for selected services including monitoring and control of home or business surveillance or security systems, automation systems, and the like, and a personal assistant service which handles various types of content, as described in detail below. Although the illustrated embodiment includes a surveillance system, an automation system, a traffic count system, and a personal assistant system or service, only one of the systems or different groups of systems may be provided in alternative embodiments.

The system of FIG. 1 comprises an on-line portal or website 10 associated with a website address which provides user access to the portal or website over a public network 12 such as the Internet. The portal 10 can be implemented as a server or computer. A similar portal may be provided in a private network in alternative embodiments. FIG. 1 illustrates a plurality of end users A, B . . . X connected to on-line portal or gateway 10 using a web browser on a communication device 14 which may be a personal computer (PC), laptop computer, mobile device, or any other device capable of running web-browser software. The portal is also linked to devices at various user locations 15 (A, B . . . X) in order to monitor, control, and receive data from those devices, as discussed in more detail below. The user devices may be security or surveillance devices such as cameras 16 or alarm systems, automation systems 18 for homes or other venues which control various systems such as lighting 20, irrigation 22, heating, air conditioning, building access, communication systems, water, energy, utility metering, smart appliances, and the like, and traffic detector devices which may be cameras and which may be used just for traffic detection or may also be surveillance devices used in a building surveillance system.

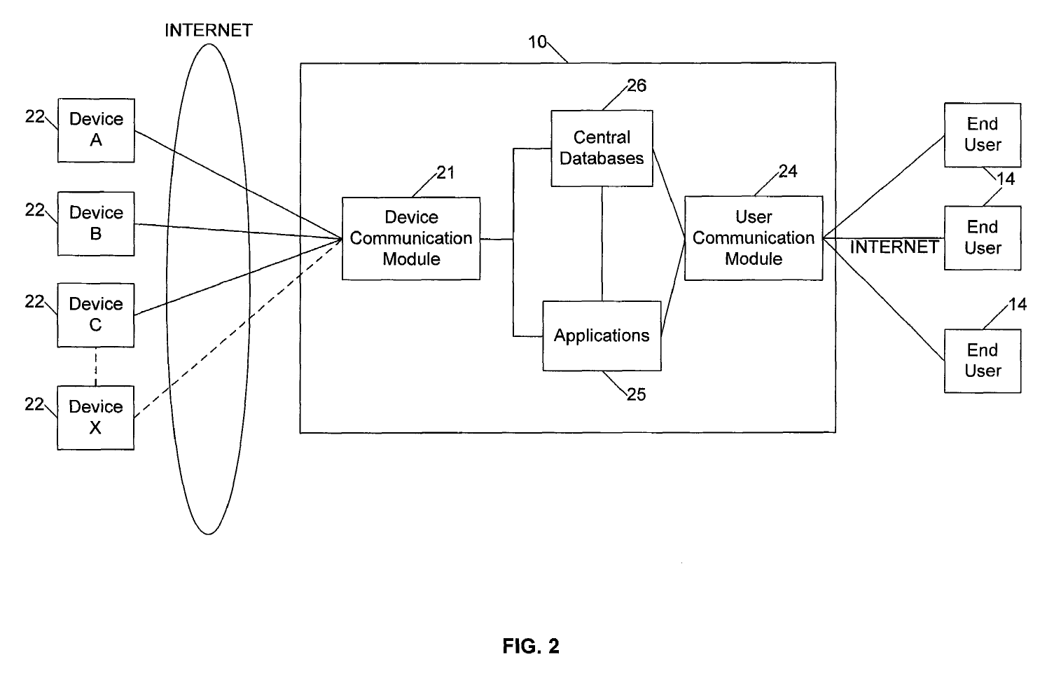

The on-line portal or user device management/access system 10 is arranged to allow users to access, control and retrieve digital services, as well as to deliver services and content to users. One embodiment of the system is illustrated in more detail in FIGS. 2 to 19 and may be located at a central facility such as an Internet data center. The system includes a first, device communication module 21 for linking to user system devices 22 at user locations or buildings, such as cameras, other building security devices, building automation devices, and the like, a second, user communication module 24 for linking to users 14 over a public network such as the Internet, a plurality of application modules 25 and a data base or data bases 26 linked to the application modules, as illustrated in FIG. 2. The application modules access raw data in the data bases, perform programmed calculations either automatically at periodic intervals or on demand from end users, and provide results to the users. The application modules may be provided on one server or distributed among several servers.

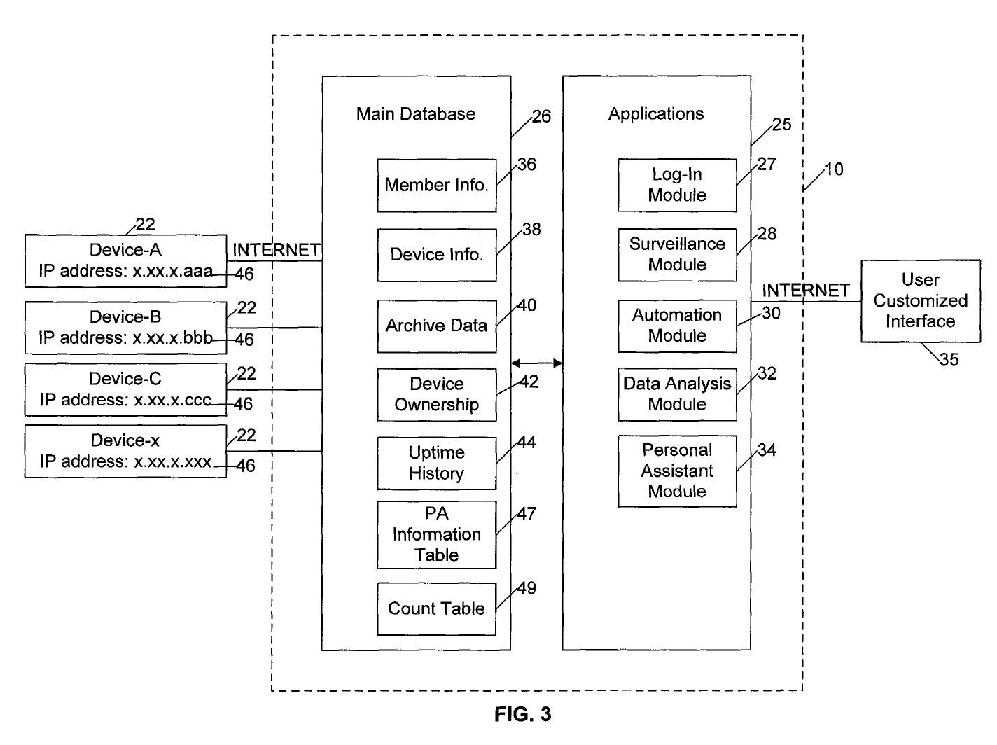

The application modules 25 and data base 26 are illustrated in more detail in FIG. 3. This drawing illustrates one user communicating with the on-line system for access to system devices 22 associated with that user. However, in practice, a plurality of users may communicate with the system simultaneously while the system in turn communicates with user system devices at various locations associated with currently registered users. Although the communication modules are not included in FIG. 3, these modules are each linked to the application modules and data bases as in FIG. 2. As illustrated in FIG. 3, the application modules include a log-in module 27 which controls user log-in, a surveillance module 28 which controls and monitors surveillance or security devices at buildings or facilities associated with end users, an automation module 30 which controls and monitors automation systems in buildings associated with end users, a data analysis module 32 which performs various types of data analysis as discussed below, and a personal assistant module 34 which stores and handles various types of user content, particularly information on devices owned and services used by the user. The on-line portal system or website may include only one, some, or all of the modules of FIG. 3, and may include additional modules to provide other user services if desired.

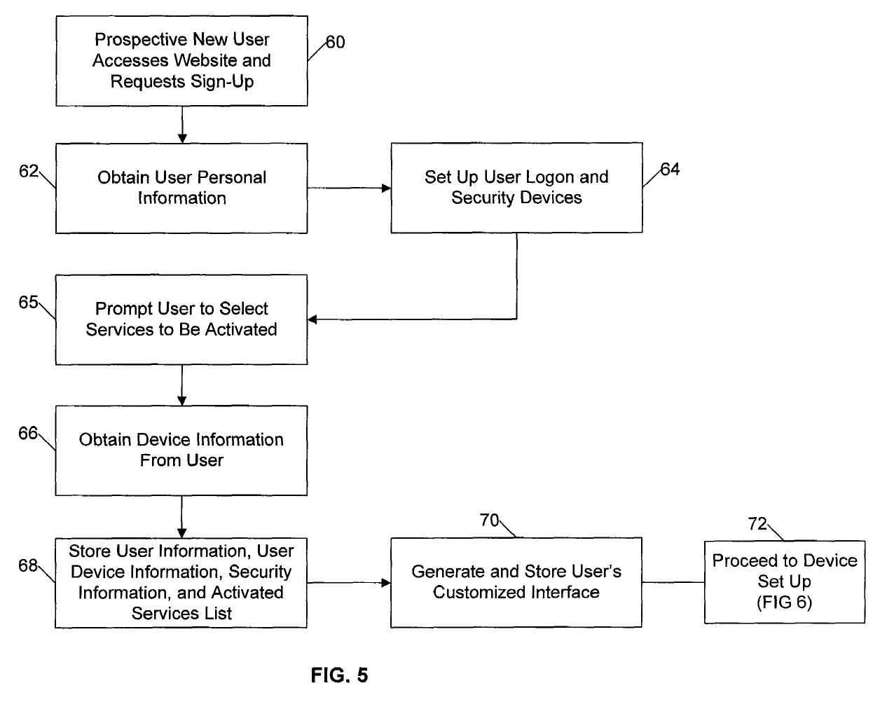

An end user or registered user who is properly signed on or registered with the system can open a user customized interface 35 on their local web browser in order to select services, as described in more detail below in connection with FIGS. 5 to 19. The data base 25 includes various tables of data, such as a member information table 36, device information table 38, archive data table 40, device ownership table 42, uptime history table 44, a personal assistant information table 47 associated with the personal assistant module, and a traffic count table or storage module 49. Other information tables may be included in various embodiments, and each table may comprise a plurality of tables associated with the listed function. The data bases organize and store all data from devices, end-user preferences, and derived data from calculations performed on raw data. The data base may be provided on one server or distributed among several servers.

As illustrated in FIG. 3, the on-line portal system is also linked to the end user's devices 22 which have been registered. Any number of end user devices may be linked to the system, based on the initial set up for each user, and the device information table stores information such as device identification information for each end user device associated with the system. The information may include manufacturer name, model identification, information enabling the device to be addressed from a network (such as an IP address 46 or the like), and login information for the device. The devices 22 registered for each user may be located at one or more buildings in various different locations, and may comprise cameras, entry alarms, automation systems, and the like.

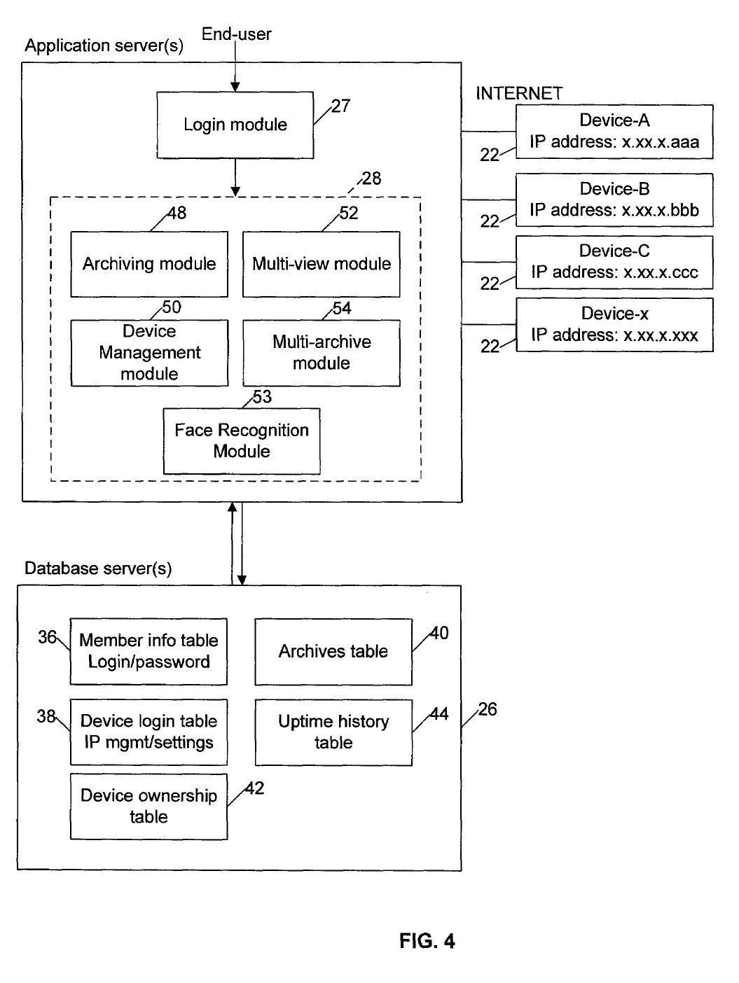

FIG. 4 is a more detailed block diagram of the surveillance module 28 of FIG. 3, illustrating the link between this module and the user devices 22, which in this case are surveillance devices such as cameras and the like, the log-in module 27, and various data tables in the main data base 26. As illustrated in FIG. 3, the surveillance module 28 has an archiving module 48, a device management or control module 50, a multi-view module 52, and a multi-archive module 54, and may also include a face recognition module 53.

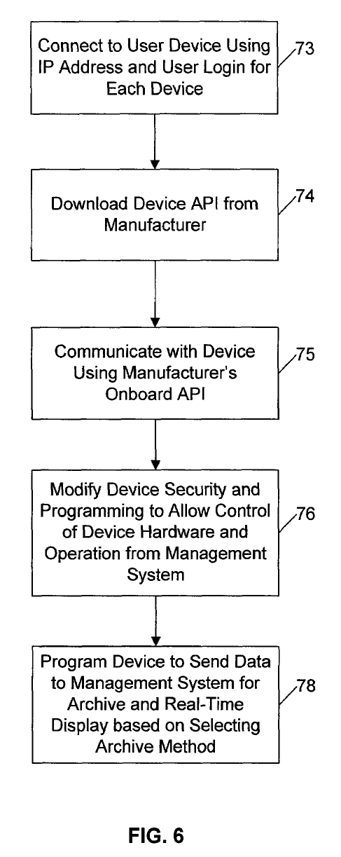

FIGS. 5 and 6 illustrate steps of one embodiment of a method of signing up a new user for the system of FIGS. 1 to 4 and the steps for an end user to operate the system after they have signed up. As illustrated in FIG. 6, in step 60 the user first goes to the designated website address or uniform resource locator (URL) for the device management system or website, and requests sign-up. This opens a web page where the user can enter the required log in information (step 62) and select a user name and a password (step 64). A third security element may also be implemented at this stage, such as biometric information (a fingerprint or the like), a universal serial bus (USB) key, or other security measures such as digital certificates in order to identify a particular user. The user information and associated log-in name, password, and other security measures if implemented, are stored in the member information table 36.

The user is then prompted to select services which they would like to have activated for their account (step 65). In one embodiment, the services provided by the system are as follows:

### 1. Surveillance (operated by surveillance module 28).—Control and management of facility security/surveillance devices.

### 2. Building automation (operated by automation module 30)—Control and management of facility automation systems.

### 3. Data analysis/traffic count (operated by data analysis module 32)—Analytics performed on data collected by traffic count devices.

### 4. Personal assistant (operated by personal assistant module 34)—Storage and management of information on items purchased by users, utilities used by users, and various services associated with the items and utilities.

### In step 65, the user selects the modules or services for which they want to sign up, and may select one module, any combination of the above modules, or all of the modules.

In step 66, the user is prompted to enter any information needed to activate the requested service. For example, if the user has selected surveillance, they are prompted to enter information on their surveillance system, for example the manufacturer and type of each security device and information required to address the devices directly from a network, such as IP addresses for the devices to be registered, as well as the login information for each device, if already set up by the user. In another embodiment, the manufacturer and model information need not be entered by the user. In this case this information may be obtained from the device itself by addressing and querying the device from the network. Similarly, if automation is selected, the user enters the manufacturer information, the IP address, and the login information for their automation system interface. In each case, the user also selects an archiving option for data collected by the management system from the respective devices, such as a storage limit (number of days or amount of storage), and an archiving method such as set interval, motion detection (in the case of surveillance devices), continuous, or other.

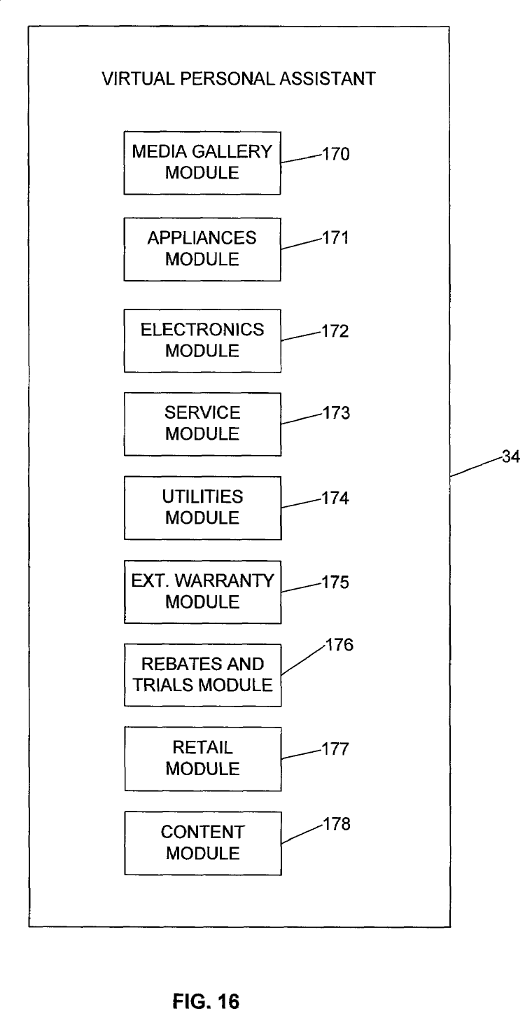

If the user selects any modules in addition to surveillance and automation, they may enter associated information on sign up and/or later. For example, for data analysis/traffic count, the user may select a type of data to be stored and analyzed. In the case of cameras, this may be count of traffic during certain time periods, for example. If the personal assistant module is selected, the user enters device information such as make, manufacturer, warranty, and the like. As new appliances, electronic devices, or other items are purchased, they can be added to the data stored in these modules for the user as described in more detail below in connection with FIGS. 16 to 19.

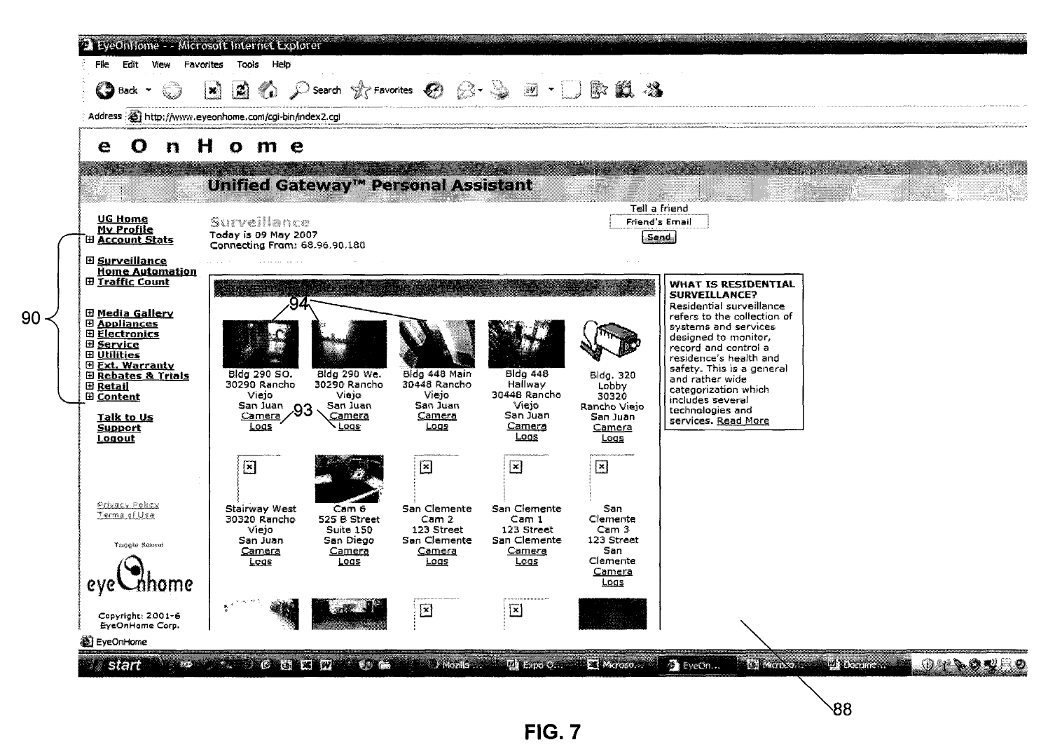

As the sign-up information is collected from the prospective new user of the system, it is stored in appropriate tables in the database 26 (step 68). The user log-in information is stored in member information table 36, all of the device information such as IP addresses, manufacturer, and login information is stored in device information table 38, and device ownership information is stored in table 42. The system is also programmed to generate and store a customized user interface for the new user (step 70), which includes selection keys or buttons for each of the modules selected by the user and the usual buttons such as support, home, logout, and contact. The customized user interface for the individual end user uses IP standards, and may use Hypertext Markup Language (HTML), Dynamic HTML (DHTML), Asynchronous JavaScript and Extensible Mark Up Language (XML) or AJAX, Java programming language developed by Sun Microsystems, and Flash authoring software developed by Macromedia, among other software. An example of a customized user interface 88 is illustrated in FIG. 7.

A device set-up process (72) is carried out either during or after the user set up process of FIG. 5, and this happens in the background since it requires no further user input. The steps of the device set-up process are illustrated in FIG. 6.

The system first connects to each user device using information allowing the device to be directly addressed via a network, such as an IP address 46 as previously entered by the user (73), and the user login if already set up. The communication module then connects to the device manufacturer's website and downloads the application programming interface (API) for the device from the website (step 74), unless this information has already been obtained for other such devices previously set up by the system. The manufacturer and device identifying information may be obtained from the user on set up, or may be obtained by the system by querying the device itself. Once the API is obtained, the system communicates with the device using the manufacturer's onboard API (step 75). The device security and programming is then modified to allow control of the device hardware and operation of the device by the device management module 50 in the case of the surveillance system, and operation by equivalent control modules in the case of the automation and traffic count modules (step 76). A secure login for the device may be set up in this step if the user has not yet set up a log in for the device. In this step, the device security is modified to allow control of the device hardware from the on-line portal system. The device set-up is also modified so that data collected by the device is sent in real-time to the on-line portal system based on the selected archive method (78), where it is archived in the archive data table 40 and can be displayed to an end user on request. The data is sent using file transfer protocol (FTP) or similar file transfer language.

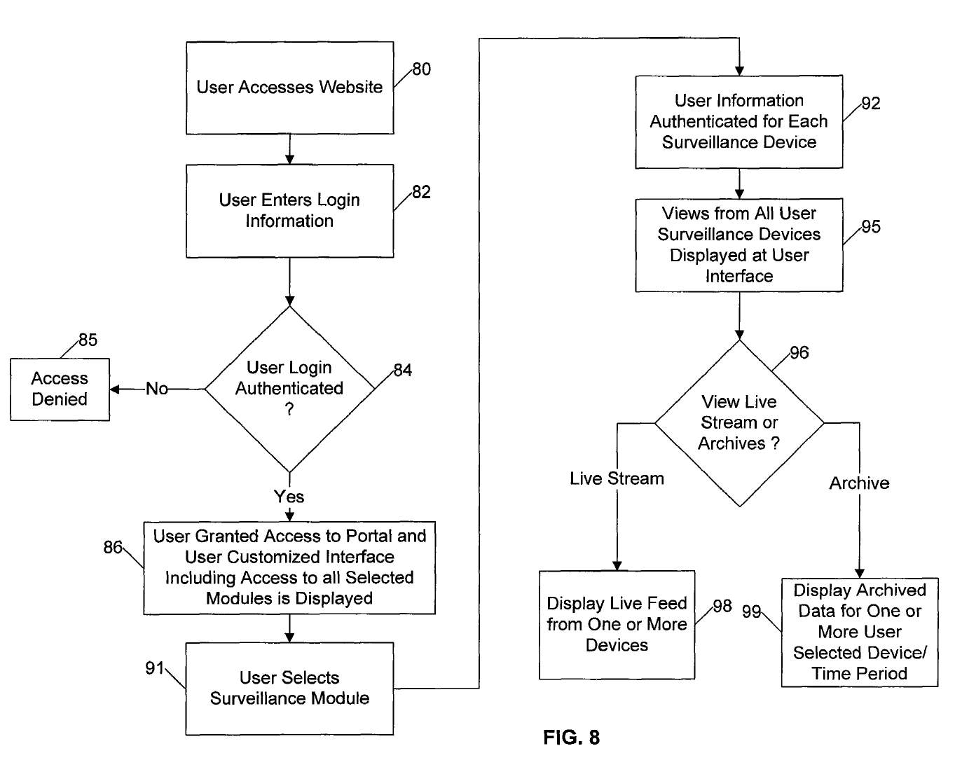

Operation of the system when a previously registered user logs on and requests surveillance information is illustrated in more detail in FIG. 8. As illustrated in FIG. 8, a user first accesses the website by entering the URL of the on-line portal or website in a web browser window (80). The user then enters their login information (82). In step 84, the system authenticates the login information using the member or user information data base or table 36. If the user is not authenticated, access may be denied (85), or the user may be provided with another opportunity to re-enter the login information before access is denied. If the login information is successfully authenticated, the user is granted access to the portal with their customized display interface displayed in their web browser screen (86). FIG. 7 is an example of a customized display interface 88 for a user who has signed up for all the modules listed above. On initial log in, only the menu 90 on the left hand side of the interface or screen 88 is displayed. As illustrated, all the modules for which the user has requested service are displayed as click-on buttons 90 at the left hand side of the screen, although they may be positioned differently on the screen in alternative embodiments. The user may then click on any button to access a desired service. The buttons labeled “media gallery”, “appliances”, “electronics”, “service”, “utilities”, “ext. warranty”, “rebates and trials”, “retail”, and “content” are all part of the personal assistant module and are described in more detail below in connection with FIGS. 16 to 19. In the example of FIG. 8, the user selects surveillance by clicking on the surveillance button on the left hand side of FIG. 7 (step 91).

After the user clicks on the surveillance button or selection on screen 88, user information for each surveillance device is authenticated by the server against the security access information required for each security device or camera (step 92). Upon acceptance of the user or member information, an initial archive view or small window 94 of all cameras assigned to (or granted access to) by the member or user appears in the user interface 88, as illustrated in FIG. 7 (step 95). The camera location and building address appears under the view received from that camera, along with selection buttons or keys 93 labeled “camera” and “logs” (see FIG. 7). For example, the display window in the upper left hand corner in FIG. 7 is from a camera in building 290 South at the address listed under the camera location. The buttons under the address allow the user to select live stream or archive views from the respective cameras (step 96). If live stream is selected, the live feed from that camera is displayed in the browser window (step 98). The user may also select a multi-view option which displays live stream from more than one camera simultaneously within one browser window, as provided by the multi-view module 52 of FIG. 4. The user can select any combination of cameras at any or all locations, or all cameras, in the multi-view option. If archive or logs is selected, the user selects a time period and archived data for the selected device over that time period is displayed in the browser window (step 99). If the user selects a multi-archive option, the archived data for any selected combination of multiple devices over the selected time period is displayed. In other words, the data for a selected time period is replayed for all selected cameras simultaneously in a single window. This option is provided by multi-archive module 54 of FIG. 4.

The surveillance module 28 connects to and communicates with all surveillance devices associated with a registered end user, and allows users to keep in contact with any selected surveillance devices at one or more selected locations, such as security cameras and the like, over the on-line portal 10. Users are also enabled to direct or control operation of these devices over the on-line portal 10. The user can also add new security devices to an existing surveillance system even if made by a different manufacturer and can communicate with all devices over the portal 10 even if running on different software. The service also allows the user to review archived data from one or more security/surveillance devices and performs periodic checks to monitor proper operation of the devices.

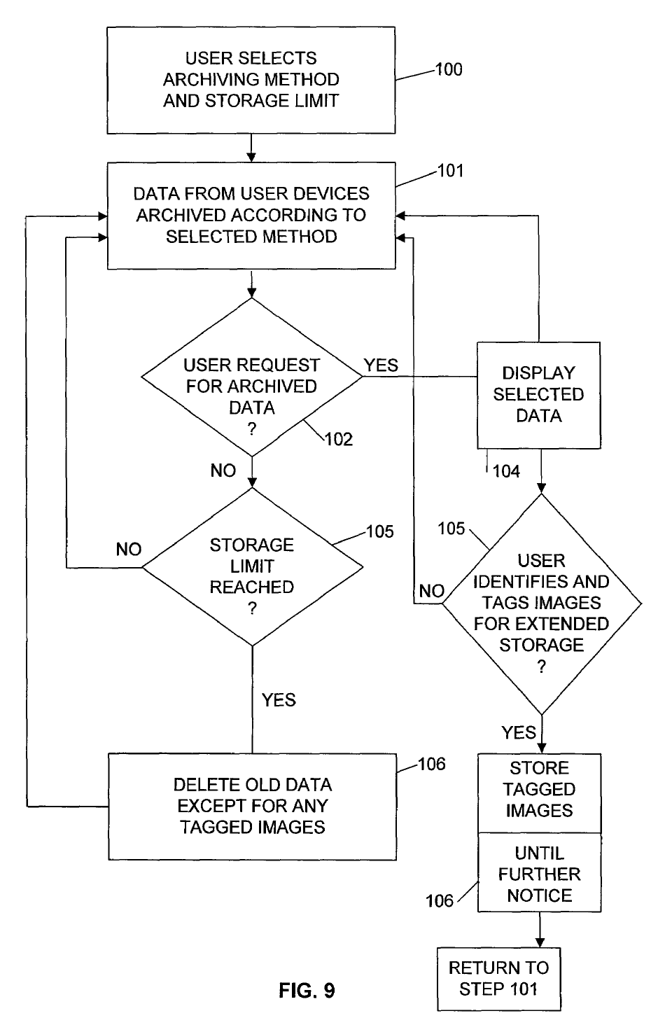

FIG. 9 illustrates one embodiment of an archiving method in the surveillance system of FIGS. 1 to 8 in more detail. In step 100, a user signing on for service (or a user who wants to change the archiving option at a later time) selects an archiving method and a storage limit. The archiving method may be continuous, in which case the system receives and stores a continuous feed from selected user devices. Alternatively, the user may select set intervals for archiving data, for example Friday 7 pm to Monday 7 am every week, or daily from 7 pm to 7 am, or may select archiving only on motion detection, or archiving of a certain number of frames per second, or other archiving methods. The storage limit is the limit for storage of archived data, and may be selected to be a number of days for which data is stored, or may be an amount of storage space. Once the archiving method is selected, data from user devices is archived or stored according to the selected method (step 101). At any point, a user accessing the surveillance module may request display of archived data (step 102). If archived data display is selected, the selected archive data is displayed in the user interface 88 in step 104. This selection may be for a particular camera for a particular time period, for all cameras (multi-view) for a particular time period, or the like. On viewing a display of archived data (or live data), the user may identify and tag images for extended storage (step 105), and the selected or tagged images are then stored by the system until further notice (step 106). The system continues to store data in the archive data base until the storage limit set by the user is reached. Once the storage limit for archived data is reached (108), old images are deleted according to the member archive limit settings (109), except for any tagged images, and the system continues to archive new data while deleting old data which is over the selected storage limit and which is not tagged for extended storage.

In addition to the above functions, the user has the option to control operation of their surveillance devices automatically from a remote location using on-line portal 10. A “manage devices” option may be provided on the screen for this purpose. The user may control switching on and off of surveillance devices during selected time period, for example “switch on all front entry cameras at 6 pm”, and may modify device operation as desired. Other options are an automated call to a user's cell phone or an email to the user if motion is detected on one selected camera or any camera during a specified time period.

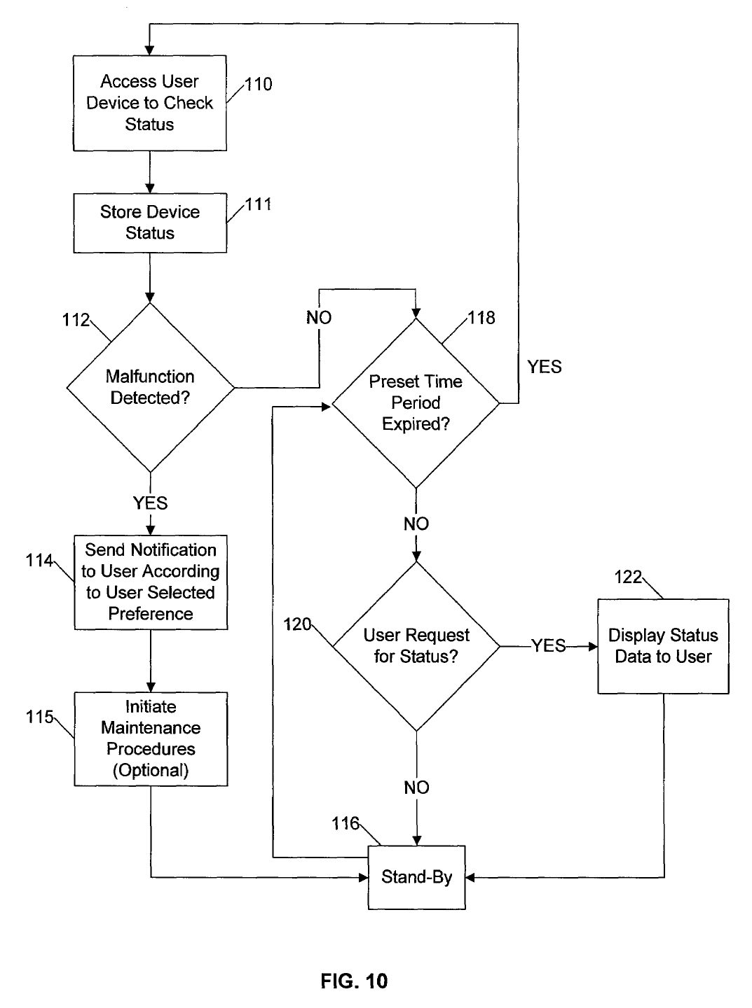

Once the surveillance option has been selected by a user, the surveillance module carries out various operations automatically in the background, without input from the user, and regardless of whether or not the user is signed on. Such operations are controlled by the smart device management module 50 of FIG. 4. The management module controls the initial programming of devices to communicate with the surveillance module as described above in connection with FIG. 6, and also carries out monitoring of device operation as illustrated in FIG. 10. The same method is used for monitoring operation of all devices associated with the system on a selected schedule. For example, operation of all surveillance devices such as cameras and other security devices is checked at predetermined intervals or on a preset schedule, as illustrated in FIG. 10. The schedule may be different for different devices and for devices associated with different users. The camera is accessed in step 110 using a “ping”, and the status information is stored in the uptime history table 44 in step 111. The information is checked for malfunction in step 112. The responsible party is notified (step 114) if any problem is detected. Maintenance procedures may optionally be initiated (step 115) in the event of a detected malfunction, for example a service provider for the device is automatically contacted and asked to schedule a maintenance visit with the user/responsible party, or this step may be left up to the user. If no malfunction is detected, the system is on stand by status (116) until the preset time period expires (step 118), at which point the device is again accessed to check status and the status information is stored. At any point, if a user requests data from the uptime history table 44 for one or more of their registered devices (step 120), the device status information is displayed in the user's customized interface or window 55 (step 122), after which the device returns to stand-by status until the next scheduled status check.

In FIG. 10, the smart device management module uses a “ping” to communicate with every registered device of every user signed up for surveillance and to check the status of all devices according to the preset schedule for the various users. In another embodiment, the management module may also initiate a potential device malfunction procedure if one or more scheduled communications with the device, such as data downloads, do not take place. This malfunction detection method may be used in addition to, or in place of, the sending of a “ping” to the device. The malfunction notification may be customized for different devices based on the reliability of the Internet service with which they are associated. For example, a failure to communicate at two, three or more successive scheduled data transfer times may result in a malfunction detection and notification to the user.

In prior art surveillance systems, it is typically not possible to monitor individual surveillance units for maintenance purposes, so the owner often does not know when a camera or recording unit has become inoperative until after an event has happened. The management module of this embodiment automatically checks the operation status of all units in a surveillance system at periodic intervals so that problems can be taken care of as they occur, providing a preventive maintenance scheme.

In addition to surveillance devices such as cameras which record activity in selected areas inside or outside a building, other types of security device may be included in the surveillance module, such as burglar alarm devices, smoke alarm devices, or the like. In this case, a user may be automatically notified in the event one or more such devices are actuated, in addition to notification of emergency personnel. The user may also add a car alarm to the system for monitoring purposes.

In addition the above, in one embodiment the surveillance module may also allow users to share access to surveillance devices with others, either on a temporary or permanent basis. The system may also allow the user to check logs of web IP addresses which logged onto the surveillance system. Unknown IP addresses in such logs may indicate potential breach of the system by hackers. The user can also add new surveillance devices to the system as desired, using an equivalent method to that illustrated in steps 66 to 72 of FIG. 5. The system then uses the same device set-up procedure of FIG. 6 to set up new devices.

In one embodiment, the surveillance system may also include a face recognition module 53 (see FIG. 4) which processes images received from cameras in accordance with user requests in order to identify known individuals. In one example, users may provide images of individuals who they wish to monitor, and these images are stored in the data base. The server then processes images received from cameras and compares with the stored images using face recognition software. If a match is found, a notification may be sent to the user, or some other pre-defined action may take place.

The automation module connects to and communicates with home or business automation and control systems which control operation of various devices and systems, such as lighting, heating, air conditioning, building access, irrigation, energy management, appliance operation, utility metering, and the like in homes, offices, factories, and automobiles. The user is connected over the on-line portal to a home or facility automation interface when they select “Home Automation” in the user interface side panel, and can monitor and control operation of any linked device or system from a remote location. For example, the user can direct specific actions in real time to effect physical changes in the device status at one or more locations either individually or in pre-specified groups, for example turn lights off at all locations at 7 am, or open or lock a door at a specific time.

With this system, the user can control operation of a wide range of different devices at different locations from a single user interface or portal, wherever they are located, as long as they have Internet or network access. The system tracks device status, usage, and activities and initiates automated actions according to preset rules defined by the user, and sends appropriate notifications to the user. The user may make adjustments manually using their remote access through their customized online portal or gateway interface.

The data analysis or traffic counter module 32 may work in conjunction with the surveillance module or may be completely independent from the surveillance module. In some embodiments, users may sign up only for traffic counting services or the system may provide only traffic counting and not surveillance service. The traffic counter module 32 is used to track data collected by devices associated with the traffic counter module and to perform data analysis and generate reports using the data, based on user requests. In one embodiment, the data analysis module 32 uses images from any compatible capture device such as an Internet protocol (IP) camera or IP video server taking feeds from analog (CCTV) cameras, and analyzes the images to be used in counting the number of people or objects in one or more locations within a facility. This analysis may use directional movement, face recognition, and location overlay (multiple detection criteria covering the same point or location). The results of the analysis may be presented to the user in various different formats, such as graphs, tables, or other numerical reports.

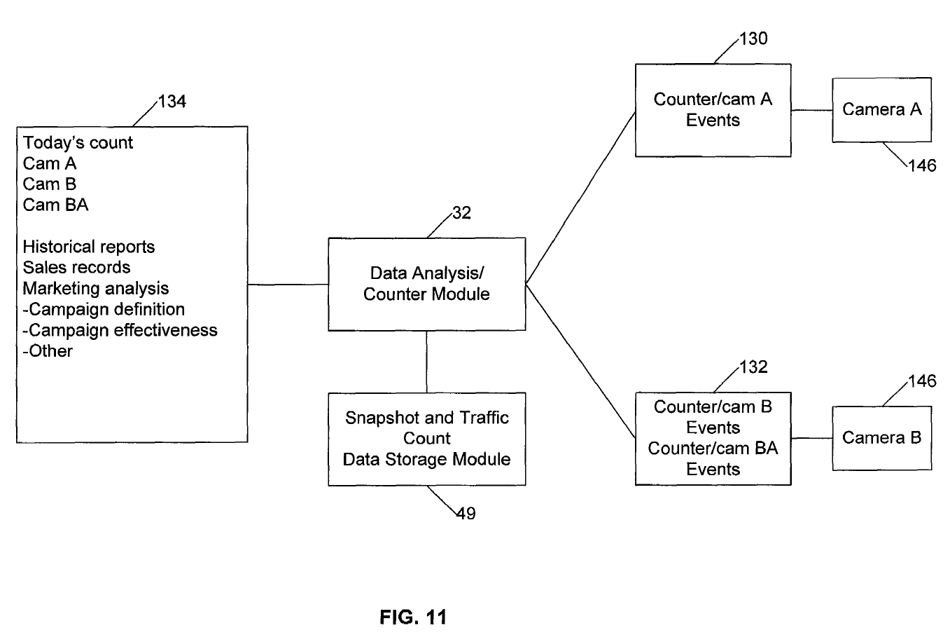

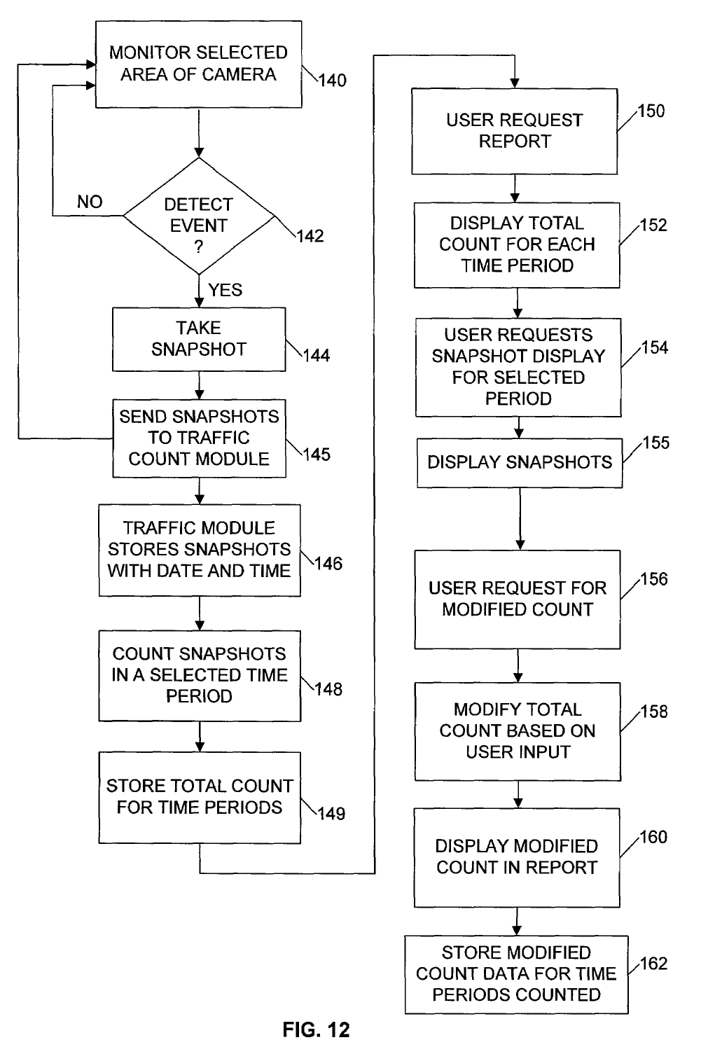

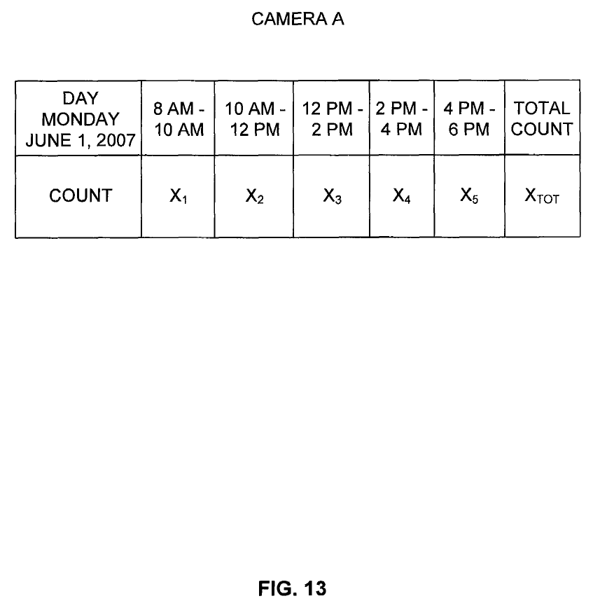

One embodiment of the traffic count module is illustrated in FIGS. 11 to 15. FIG. 11 is a schematic representation of one example of the data analysis or traffic count module 32, while FIG. 12 is a flow diagram illustrating one embodiment of a traffic counting method using this module, and FIG. 13 is an example of data displayed to a user. In FIG. 11, module 32 is associated with counters 130, 132 which count traffic detected by cameras 146 at two different locations, although a greater or lesser number of cameras may be used for traffic counting in alternative embodiments. The cameras 146 may comprise some or all of the cameras associated with a surveillance system, or may be a completely different set of cameras. The camera or video server to which the camera is connected may be programmed to monitor specific image areas for movement or change in the image, which corresponds to event detection, and to take a snapshot on detection of an event. In the case of a retail store, such event detection may be used to count the number of potential customers who visit a store, or who view a display case in a store, for example. In one embodiment, one or more overhead cameras may look down on several display cases and detect events associated with people visiting each case. The cameras are programmed or control to send each detected event to the server, which stores event detection and traffic count data in the associated data storage module 49. The module 32 counts any object as specified by the user when setting up this option, such as people, automobiles, animals, and the like. It may be set up to count traffic at one camera (Counter/cam A or Counter/cam B) or the total traffic for two cameras (Counter/cam BA), or for more than two cameras, and to record the desired traffic counts at the selected cameras or combination of cameras. The data analysis/traffic counter module 32 may have a marketing campaign analysis module which can calculate the change in traffic as the result of a marketing or advertising campaign based on user selection of criteria such as media, vendor, time frame, frequency, and the like. This module calculates the change in traffic after a specific advertising campaign is initiated to enable an analysis to be made of the potential effectiveness of the campaign. The effectiveness of different campaigns can be compared and reports can be generated which compare the results of various campaigns graphically, numerically, or both, together with historical marketing expenditure.

The cameras or other traffic counting devices associated with the traffic counting module 32 may be set up in the same manner as described above in connection with the surveillance module (see FIGS. 5 and 6) and may also be monitored for malfunction in the manner described above for surveillance devices in connection with FIG. 10. The initial set up and device monitoring is therefore not described again here.

In one embodiment, the data analysis module may be linked to point of sale (POS) systems or the user may enter sales information manually for this module, and the module then calculates sales effectiveness (closing ratio) and provides a corresponding report to the user.

The left hand side of FIG. 11 illustrates various reports 134 which may be generated by the data analysis module and displayed on a screen to the user, who may then print out the reports as desired. For example, the data available to a user who is signed up for the data analysis option of FIG. 7 may receive one or more of the following:
1. Today's count:
   Camera A
   Camera B
   Camera AB
   Camera C . . . Camera X
2. Historical Reports
3. Sales Records
4. Marketing Analysis
   Campaign Definition
   Campaign Effectiveness
   Other

The “Today's count” data comprises the counted traffic for any number of selected cameras over a selected time period, as well as total count for two or more cameras if desired. Sales records are collected either automatically by direct integration of the data analysis module with a POS system or by user manual entry of the data. Marketing analysis is based on user selection of campaign criteria such as timing, and the types of marketing reports requested.

FIG. 12 illustrates one embodiment of a traffic counting method for one camera, and the same method is used for each camera when two or more cameras are connected to the traffic counting module. As noted above, the camera is controlled to monitor a selected area or areas of the field of view, i.e. specific pixels or groups of pixels (step 140). An event is detected (step 142) based on a change in the selected area of the image. A snapshot is then taken (step 144) and the snapshot or image is sent to the traffic count module (step 145) and stored in the traffic count data base or table 49 (see FIG. 3) in step 146, together with the date and time associated with the snapshot.

Based on time periods selected by the user, the traffic counting module counts the total number events or snapshots received in a selected time period or a series of successive time periods (step 148), and the total counts are also stored in data base 49 (step 149). When a user logs on to the traffic count service and requests a report (150), the count for each time period and the total count for the entire scheduled time is displayed (152). One example of a traffic count display for one camera and one day is illustrated in FIG. 13. The user may want to monitor traffic for each day a store is open, for the store open hours, for example from 8 am to 6 pm. In FIG. 13, the day is broken down into two hour time slots, although a greater or lesser amount of time may be used for each time slot as requested by the user. For each time slot, the total number of events for a particular camera is counted and displayed in the report (x₁ to xₙ). The total count for all time slots as displayed in the final slot may be divided by two to provide the count in this box, since each person entering the monitored area also leaves the area at some point, resulting in a second snapshot. A similar display may be provided for each camera associated with the traffic count module, and for combined camera counts if desired.

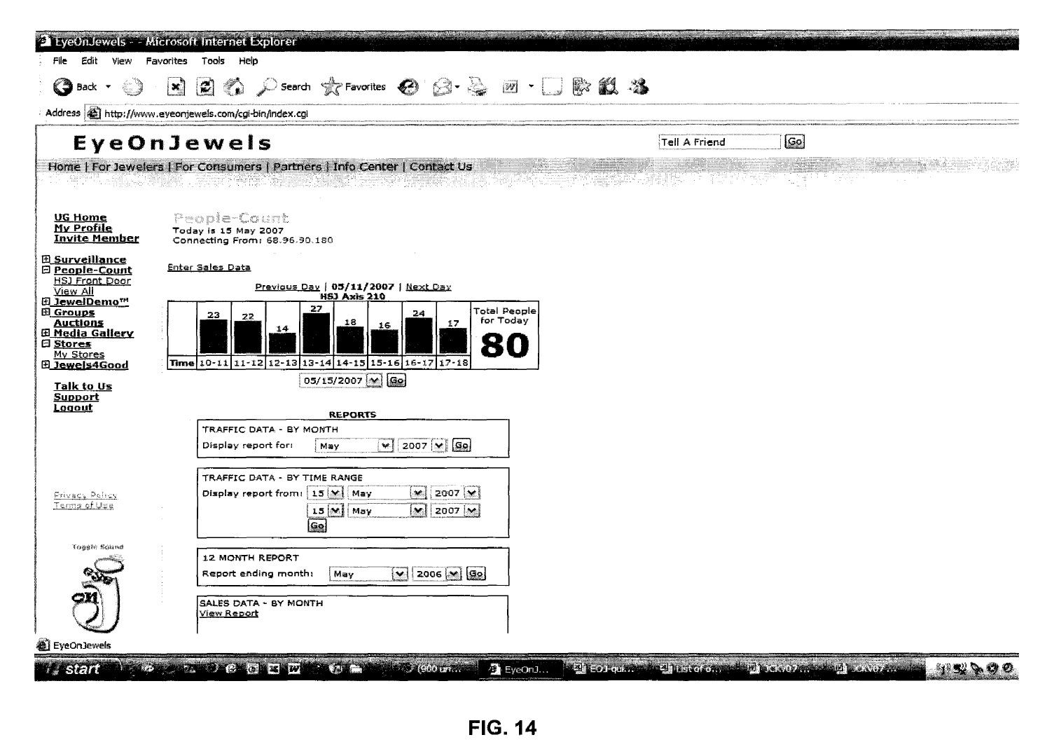

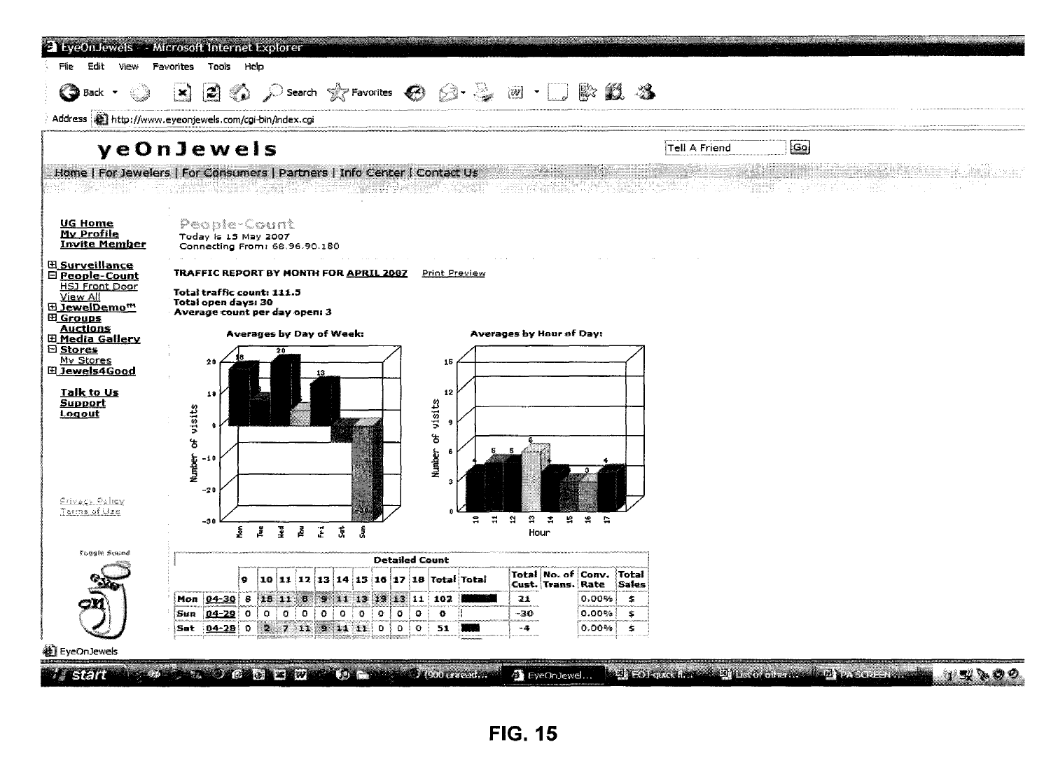

FIGS. 14 and 15 are screen shots illustrating other traffic count reports which may be selected by a user. In FIG. 14, the traffic count for each hour of a selected day is displayed as a bar chart as well as a number, as well as the total count (sum of counts for each hour divided by two). The user has the option of entering sales data and selecting different dates to view. They may also select a report showing traffic data by month, by time range, a twelve month report, and sales data reports.

FIG. 15 illustrates a traffic report by month, with bar charts of averages by day of week and by hour of day, as well as a detailed count for each day. Sales or transaction information may also be included, as indicated.

The user has the option of clicking on any count time period for any day displayed for a particular camera (step 154), and if this option is selected, a screen appears in which the snapshots or images taken during that time period by that camera are all displayed (155). The user can view these snapshots and has the option of requesting a modified count (step 156) if they feel that some snapshots are duplicates of the same individual or for some other reason do not represent a customer entering a monitored area (e.g. they are of store personnel or other non-real traffic events). If a modified count is requested, which is done by a user clicking on an “delete snapshot” button under the snapshot, for example (step 158), the total count is modified (160) based on the user input, and the modified count is displayed (162). The modified count data is then stored in place of the original count data for that time period.

Reports can be provided by the hour, by the day, by the week, or any other selected time period, and users can also view accumulated historic count reports over extended periods of time to determine any changes in traffic. Such reports can be tied to the timing of various types of marketing event, such as a specific advertising campaign, sales, different designs in show cases, and the like. For example, if an advertising campaign is carried out on different radio and TV stations, the traffic after airing of an advertisement on different stations is monitored to determine which station was the most effective. This information can then be used for future marketing campaigns, with marketing expenses directed to the stations which proved to be most effective in increasing traffic. Reports may also be generated which tie actual sales information into traffic count. The sales information may be manually entered by store personnel or may be received and stored automatically from a POS system linked to the traffic count module. This can help to determine the effectiveness of sales personnel. For example, if a large number of sales are recorded each time a particular sales person is working, even when the traffic count is low, this indicates that the person has an effective sales technique. If sales for a certain time period are low even when traffic is high, sales techniques may need improvement.

The system may also be used to measure the effectiveness of different types of marketing campaigns, such as sales, special offers, and the like. The effectiveness of different counter displays can also be determined, for example if one particular display draws more traffic and/or results in more sales, other displays can be modified based on these results. As with the surveillance module, the data analysis or traffic counting module may also incorporate a face recognition option which compares received images to stored images previously provided by users, and notifies users of any matches found.

The on-line portal system 10 as illustrated in FIGS. 3 and 7 also includes a virtual personal assistant (VPA) system 34 for users who sign on for this service. The system 34 includes a plurality of modules as listed on the left hand side of FIG. 7 under the traffic count button and as illustrated in FIG. 16. The modules comprise:

### 1. Media Gallery module 170—Allows the user to store their own gallery of images/snapshots, videos, music and the like.

### 2. Appliances module 171—Storage of information on user owned appliances such as refrigerators, ovens, dishwashers, washing machines, and the like.

### 3. Electronics module 172—Storage of information on user owned electronic devices such as computers, printers, television sets, and the like.

### 4. Service module 173—Links to companies which do service on any user devices stored by the system.

### 5. Utilities module 174—The Utilities module manages the phone, gas, electricity, garbage, cable TV, and other utility services that a home or business owner receives.

### 6. Extended Warranty module 175—Storage of user warranty information with a tickler or reminder service prior to warranty expiration.

7. Rebates and Trials module 176—Records information on rebates sent in by user, and tracks redemption with tickler notification to the user at periodic intervals, and also stores information on any free trials to which the user has subscribed, with reminders of the trial expiry dates.
8. Retail module 177—Links retail stores to items purchased at the stores by the user. Communications regarding product recalls directed to retail module and forwarded to user.

### 9. Content module 178—This module allows a user to bookmark other websites to which they subscribe and which they may want to visit on a regular basis, so that they do not have to enter the website address each time they want to visit each website.

The appliances, electronics, utilities, service, warranty and the like modules of FIGS. 7 and 16 allow registered users or members to enter detailed, specific information about their equipment, including appliances, electronics, utilities, vehicles, and the like, into the server, where the information is stored and handled in various ways. In one embodiment, each of the personal assistant modules of FIG. 16 may be linked to a corresponding data storage table in the personal assistant information table or data storage module 47 of FIG. 3.

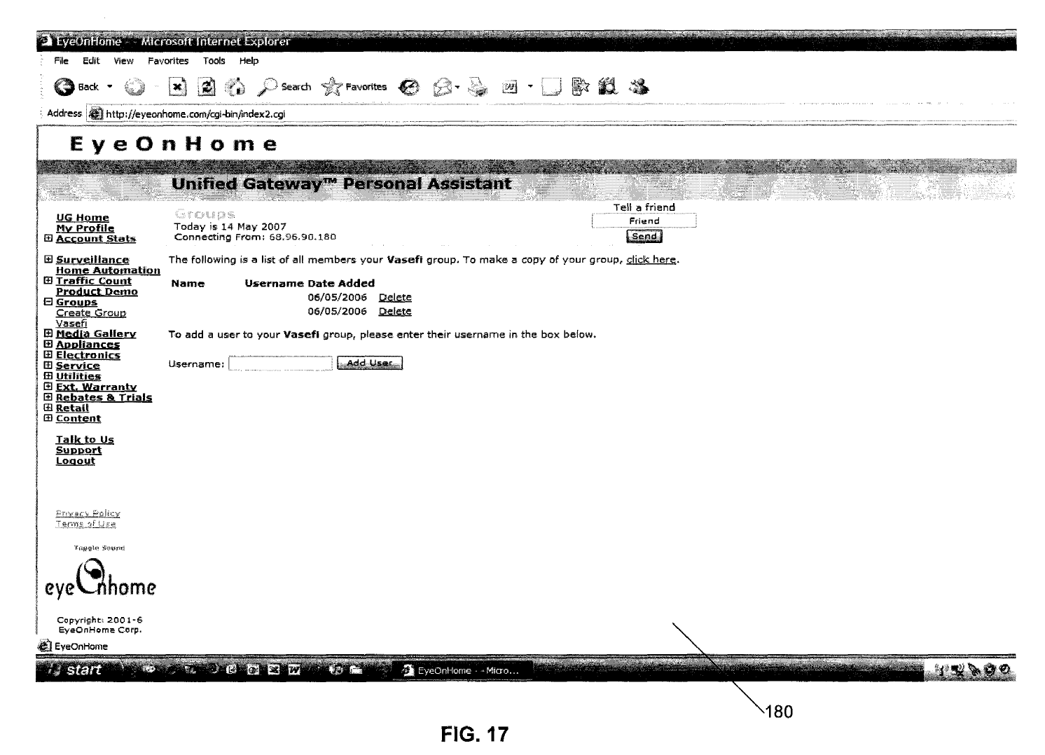

FIG. 17 illustrates an example of a screen shot or page 180 which may be displayed at a customized user interface after a user has selected the personal assistant option in the initial window or screen. In this case, a group option or module has been selected which allows a user to enter members to a group which is authorized by the user to view certain links, such as the media gallery module of snapshots or images. One such group may include family members, friends, or the like. If a user selects the option “media gallery”, they have the option of viewing images or videos or hearing music, and if one of these options is selected, they can select between different images, videos, or music as stored under each option. The user can also select which images and videos to make available to groups.

When the user purchases a piece of equipment, they enter the following information under the appropriate heading (e.g. appliance or electronics) into the corresponding module:

### Type of appliance or electronics device.

### Brand/manufacturer and manufacturer website.

### Model.

### Serial number.

### Purchase date.

### Retailer and retail company web site.

### Location.

### Warranty information (including expiry date).

### Service and maintenance information (including maintenance schedule and identification of service provider).

### Receipt (user can scan and enter the actual receipt for the device which was purchased).

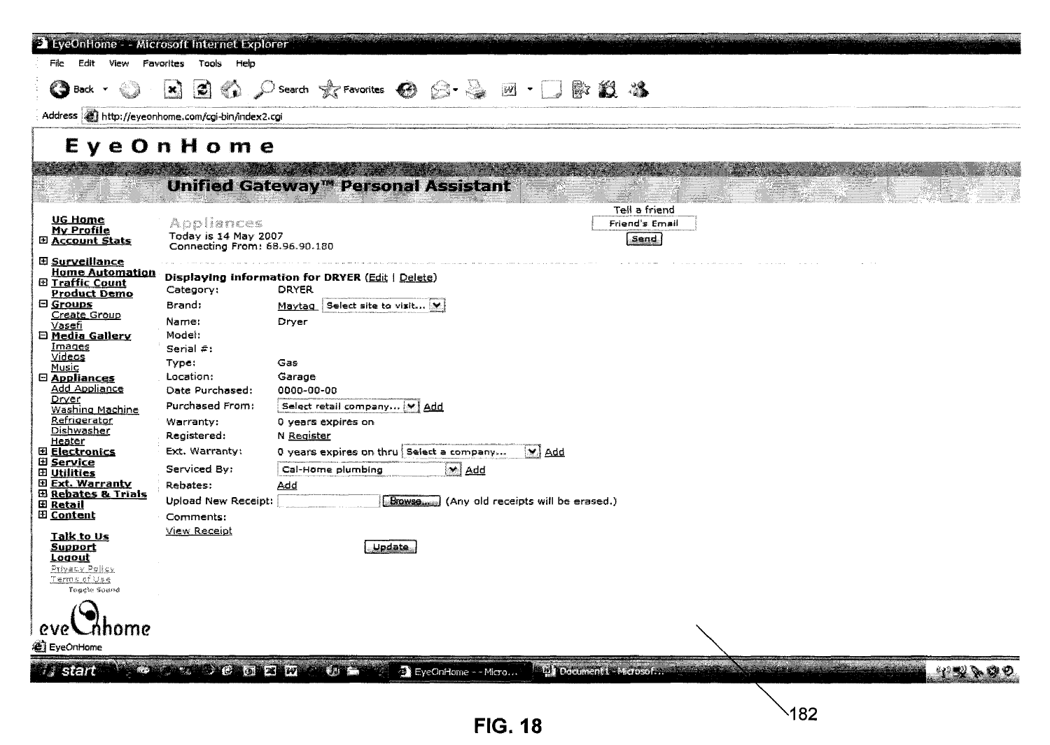

FIG. 18 is an example of a screen shot or page 182 for entry of information associated with a newly purchased appliance in appliance module 171, in this case a dryer. Similar screens or user entry pages are provided for electronics devices in electronics module 172. In one embodiment, other types of items, such as automobiles or other vehicles, may also be entered under a separate heading or option. As illustrated on the left hand side of FIG. 18, the different types of appliances entered by a user are listed under the title “appliances”, and the user can click on any one of these appliances in order to view or modify the associated information.

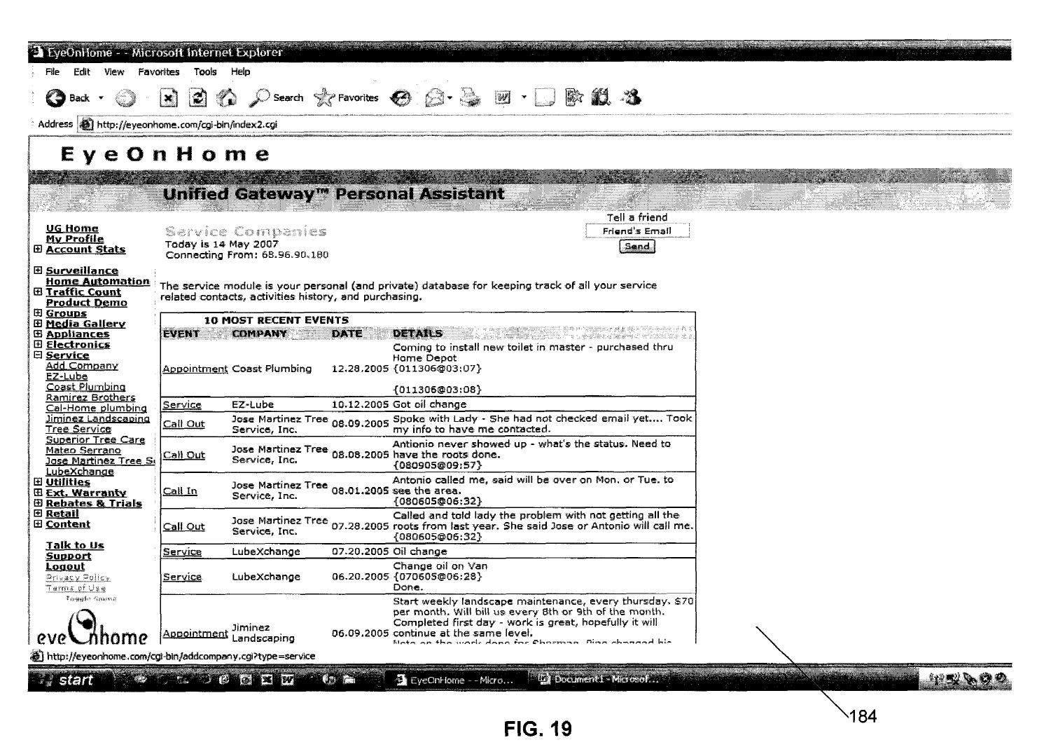

The service module 173 is a database for keeping track of service related contacts. When a user enters a service company in connection with an appliance or electronics device, the same service company information is automatically stored in service module 173. The user can also enter other service related contacts here, such as cleaning services, plumbing services, landscaping services, and the like, as well as scheduled appointments for such services. The user can also enter details and the results of such service appointments. When the user clicks on the service module option in the personal assistant system, a series of options appear, as illustrated on the left hand side of the service module screen shot or page 184 illustrated in FIG. 19. These include an option for entry of a new company and headings corresponding to service companies already entered. At the same time, a listing of the most recent service events appears on the screen. The information for each service company includes a link to the company website as well as other contact information, and the history of events associated with that company.

Utilities module 174 keeps track of utility companies with which a user does business, such as telephone, electric, gas, Internet connections, cable TV, cell phone, wastep service, and the like. The user enters information on each utility company when first setting up this module, and can add utilities at a later date as desired. As with the services module, clicking on the utilities module option on the left hand side of the screen opens a page which lists the most recent events associated with utility companies, such as service calls, scheduled outages, and the like. The module includes links to the utility company websites as well as other contact information. In one embodiment, the utilities module receives scheduled outage information automatically from utility companies and sends notifications to users in advance of such outages, and also provides reminders of scheduled service visits.

The extended warranty module 175 retrieves and stores warranty information entered by a user in the appliances and electronics modules each time a new item is purchased. The user may also enter warranty information for any items not already entered elsewhere in the personal assistant data base. The menu opened by clicking on the Extended Warranty option on the personal assistant web page lists all companies with which the user has an existing warranty, and also includes an option to add new warranties. In one embodiment, the extended warranty module keeps track of warranty expiry dates and sends notifications to users in advance of each warranty expiry. Such notifications may also include options to send a posting to an online sales website offering to sell the associated item, and to receive information on sales of similar items by retail outlets and the like.

The rebates and trials module 176 stores information on any product rebates requested by users. This information may be entered by users on entry of any newly purchased item having an associated rebate in the appliances or electronics module, and is then automatically saved in the rebates and trials module, or can be added by the user by clicking on the item in another module through a link available under the rebates and trials module. In another embodiment, rebate information may be entered by the user directly in the rebates and trials module. The rebate information displayed on clicking the rebates and trials module includes a list of each item associated with a rebate, the date of submission of the rebate, the rebate due date (expected date of receipt of rebate), and the rebate amount. This allows the user to keep track of rebates sent in and to notify the company if a rebate is overdue. The information displayed also includes a link to the item information stored elsewhere in the personal assistant data base, such as under appliances and electronics, which in turn provides retailer or manufacturer links.

The trials portion of module 176 allows a user to enter information on any trial subscriptions or services for which they are signed up. The options which may be selected for entry of trial information are retail, service, warranty, and utility. The user enters the trial expiry date, and is then provided with reminders prior to the expiry date so that they can cancel the service, subscription, or the like if desired, before being automatically signed up and billed.

The retail module 177 includes links to the websites of retail stores with which the user does business or from which the user has purchased items in the past, as well as addresses and other contact information for such stores. This module may be set up to receive information on any special offers available at such stores, and may provide such information to users either by sending messages or displaying the information when the user selects the retail module option on their customized personal assistant interface. One option is to provide information to users on new models for an appliance or electronics device with a soon-to-expire warranty.

The content module 178 provides a list of on-line businesses or companies with which the user has signed up for service, and links to the websites of such companies automatically so that the user does not always have to enter the associated website addresses when they want to utilize the service. In this way, the user only has to remember one website address, i.e. that of the on-line portal system 10, rather than multiple such addresses. The types of on-line businesses which may be stored are movie rental, music companies, email companies, search engines, on-line news or magazine services, on-line dictionary and encyclopedia services, and the like.

The various modules associated with the virtual personal assistant (VPA) system store the relevant information and process the information in order to monitor for service and warranty deadlines and to provide reminders to the users in advance of such deadlines. In one embodiment, users enter information about purchase date, location, warranty, service, maintenance, upgrade and the like. The application modules associated with the VPA system process the information entered by the user and communicate with the user as needed to inform them of any related matter regarding their equipment or utility services. The system may also be linked to manufacturer's websites to look for any recall information and to notify the user in the event of a recall of any purchased equipment. The system also provides a list of all utilities, service providers, and equipment retailers in the registered user's locale with the rating for the entity displayed and access provided for reading all feedback within the limitations provided by the intake system/interface. The information used by the appliances, electronics and other equipment-related modules may be obtained purely as a result of user entry of information and/or in collaboration with information received from the manufacturer, distributor, service provider, or recycler of specific equipment. Notifications regarding equipment may be communicated to the user in the form of web-based text, Short Message Service (SMS) or text messages to cell phones or the like, email, or voice messages informing them of any related matter regarding their equipment or utility services. Automated service, recall, and safety information may be provided to users as delivered by manufacturers or by authorities (local and federal). The retail module assists with this process by linking to retail stores and/or manufacturers of items purchased, so that any recall information is sent directly to that module for notifying the user.

The service module, if selected, is set up with links to service providers for the various appliances, electronic devices, surveillance devices, and the like for which information has been collected for that particular user. In order to activate the extended warranty module, the user enters warranty information, and may continue to add new warranty information as new devices are acquired, including automobiles and the like. If the rebate module is activated, the user can enter information at any time on any rebate request sent in to a manufacturer, for tracking purposes, and the rebate request is then tracked.

The equipment information storage and processing modules may also provide a rating mechanism for users to rate any equipment, service provider, or company from which they have purchased or received service. This results in a numerical scoring system for such equipment, company, or entity. Ratings scores may or may not be shared with a community. A process may be provided to allow the rated party to provide feedback on issues raised by users. A classified section may also be provided as a link to a local classifieds section of a website, newspaper or the like to allow users to sell and purchase items in their local vicinity. These modules may also be arranged to calculate expenses of living in a specific location by calculating costs of specific utilities, equipment specified usage rate of a specific utility, users' lifestyle patterns, and the like, and may recommend ways in which users can save of the cost of utilities.

The equipment related modules may also be set up to provide information on new modules introduced in the various fields, in case the user wishes to upgrade. The system may also provide automated service, recall, and safety information related to items purchased or utilities used by the end user and as delivered to the system by manufacturers or local or federal authorities. The system may be set up to receive such information automatically from the respective entities.

The device management system and method described above operates at a central, off-site location rather than at a user's own location. No installation of particular on-site hardware or software is needed other than the normal equipment which would be installed by a user for surveillance, automation, or the like. All that is necessary is for the user to have access to a web browser so that they can access the website, which operates like an on-line portal between the user and equipment at various locations, as well as providing a virtual personal assistant where a wide range of content or information can be collected, stored and handled at one place for that user, with links to other websites as appropriate.

The surveillance system described above allows the user to view data from a browser window at their current location at any time, from any number of device locations, either simultaneously or serially, either in real time or from archives. The system also allows the user to control operation of such devices from a remote location at any time, and automatically monitors device status and provides the user with information of any possible malfunction as well as access to stored status reports. The traffic count or data analysis module allows a user to request specific traffic counts and to access traffic and/or marketing reports 150 generated by the system 10 based on data retrieved from user devices such as cameras and other sensors. The system also allows equipment data and utility data entered by the user to be stored, accessed, and updated by the user at any time, and provides links to equipment retailer websites, equipment manufacturer websites, utility websites, and service company websites, both for access by the user and to receive any product recall or safety information for notification to the user. In one embodiment, all of these options are provided together at one website for easy access by an end user.

Those of skill will appreciate that the various illustrative logical blocks, modules, circuits, and algorithm steps described in connection with the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block or step is for ease of description. Specific functions or steps can be moved from one module or block without departing from the invention.

The various illustrative logical blocks and modules described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A method of remotely accessing and controlling devices in a building, comprising:
signing up users for at least one digital service through an on-line device management website, the digital service comprising providing each authorized user with remote access to a plurality of devices in at least one building associated with the respective authorized user;
storing data on authorized users and on devices associated with each authorized user at the website, at least some of the devices having different application programming interfaces (APIs), and the stored data including the API for each device;
communicating with each device associated with an authorized user from the website, using the API of the device;
controlling each device to send data to the website on a selected schedule;
receiving and storing data from the devices at the website; and
providing an authorized user with a customized display interface at the website, the customized display interface displaying options to the user including display options for displaying data from the devices associated with the user, the display options comprising displaying stored data from one or more selected devices and displaying real time data from one or more selected devices.

2. The method of claim 1, further comprising periodically checking the operational status of each device from the website, receiving and storing device status information from the devices, and notifying the user associated with a device if a device malfunction is detected.

3. The method of claim 2, further comprising providing a user with a device status option on the customized interface which displays stored device status information from the periodic status checks for each registered device associated with the user.

4. The method of claim 1, wherein the step of signing up a user comprises offering a plurality of digital services to the user and receiving and storing information on the digital services selected by the user.

5. The method of claim 4, wherein the digital services comprise at least a surveillance service which provides control and monitoring of devices comprising surveillance devices.

6. The method of claim 5, wherein at least some of the surveillance devices comprise cameras.

7. The method of claim 6, further comprising displaying output from at least one camera on the customized user interface via the website.

8. The method of claim 7, further comprising displaying output from all cameras associated with a user simultaneously on the customized user interface for that user.

9. The method of claim 7, further comprising providing a user with the options of displaying one or more camera outputs real time on the customized user interface, or displaying archived data for a selected time interval from one or more cameras on the customized user interface.

10. The method of claim 4, wherein the digital services comprise at least a traffic count service and at least some of the devices comprise traffic monitoring devices, the data analysis service collecting and analyzing traffic data from the traffic monitoring devices and providing corresponding traffic reports to authorized users.

11. The method of claim 4, wherein the digital services comprise at least a building automation service and at least some of the devices comprise building automation systems.

12. The method of claim 11, further comprising linking at least one automation system at a building with the website, and connecting the user associated with the automation system with an automation system control interface through the website on request, whereby the registered user can monitor and control the automation system remotely through the website.

13. The method of claim 5, wherein the digital services further comprise a personal assistant service which receives, organizes, and stores information on items purchased by a registered user.

14. The method of claim 13, wherein the personal assistant service further comprises receiving and storing links to other websites associated with an authorized user, receiving and storing item warranty information and providing reminders of warranty expiry, providing links to websites for selling and buying items, receiving and storing information on utilities used by a registered user, and receiving and storing information on companies providing service on items purchased by an authorized user.

15. The method of claim 1, further comprising providing an authorized user with a device control option on the customized interface which allows user control of an associated device via the website.

16. An on-line device management system, comprising:
a first communication module which communicates with devices over a public network in order to receive data from the devices, the devices including at least some devices having different onboard programming;
a device data storage module communicating with the first communication module which stores device identifying and onboard programming information;
a device control module which uses the stored onboard programming information for each device to control the device to send data to the first communication module on a selected schedule;
an archive storage module which communicates with the first communication module and receives and stores data received from devices;
a second communication module which communicates with users accessing the on-line management system over a public network;
a user information storage module which communicates with the second communication module and stores user information, the information including user log in information, a list of devices associated with each user, and a customized user interface for each user including access to a plurality of modules selected by the respective user, one of the modules comprising a surveillance module and at least some of the devices comprising surveillance devices; and
the surveillance module comprising a surveillance display unit having a live data viewing module and archived data viewing module, the live data module displaying live data from at least one surveillance device associated with a user at the customized user interface, and the archived data module displaying archived data from at least one surveillance device for a user selected time period.

17. The system of claim 16, wherein the surveillance module further comprises a device management module which checks the operational status of surveillance devices associated with a user at periodic intervals, and stores status information received in each status check.

18. The system of claim 17, further comprising an uptime history storage module which stores the operational status of each registered device linked to the system in connection with each status check by the device management module.

19. The system of claim 17, wherein the device management module checks the operational information received in each status check for potential malfunction of the associated device, and further comprises a user notification module which notifies a user associated with a registered device on detection of an operational malfunction of the respective registered device.

20. The system of claim 18, wherein the device management module further comprises a device status link on the customized user interface and a status display which displays stored device status history on the customized user interface on selection of the device status link.

21. The system of claim 16, wherein the live and archived data modules each have a single device option for displaying data from a single device and a multi-view option for displaying data from multiple devices simultaneously at the user interface.

22. The system of claim 16, further comprising an automation service module which communicates with at least one building automation system associated with a user, the customized user interface further comprising access to the automation service module, and the automation service module displaying an automation system control interface on the customized user interface on selection of the automation service by a user, whereby a user can monitor and control building equipment associated with the building automation system remotely through the on-line device management system.

23. The system of claim 16, further comprising a data analysis module which provides reports to users generated from data received and stored from traffic count devices associated with the respective users, the customized user interface including access to the data analysis module.

24. The system of claim 16, further comprising a personal assistant module which receives and stores information from users on items purchased by the users and services to which users subscribe.

25. The system of claim 22, wherein the personal assistant module further comprises a calendar module which stores and tracks warranty and service information related to items purchased by a user and provides reminders to users in advance of warranty expiry dates and scheduled service dates.

26. The system of claim 22, wherein the personal assistant module further comprises links to companies providing servicing and maintenance of items entered by users.

27. An on-line traffic count system, comprising:
a first communication module which communicates with traffic detecting devices over a public network in order to receive data from the devices;
a device data storage module which communicates with the first communication module and stores device identifying and onboard programming information;
a device control module which controls the traffic detecting devices using device programming information to send detected traffic event data to the first communication module on a selected schedule;
a traffic counting module which communicates with the first communication module to receive traffic event data and which counts the number of events received from each traffic detecting device during a series of predetermined time periods;
a storage module which communicates with the first communication module and traffic counting module and stores traffic data and the traffic count over successive time periods;
a second communication module which communicates with users accessing the system over a public network; and
a customized user interface for each user including access to the traffic counting module, the traffic counting module including a display module which displays traffic count information to the user, the display module including an event display option which displays each recorded traffic event during a selected time period for a selected traffic detection device.

28. The system of claim 25, wherein the traffic detection devices comprise cameras and the events comprise snapshots taken when motion is detected in predetermined camera areas.

29. The system of claim 25, wherein the traffic count module further comprises a report generator which generates reports comparing the number of events detected in predetermined regions over predetermined time periods.

30. The system of claim 25, further comprising a user input module which allows a user to delete selected events from the total count stored for a predetermined time period.

31. The system of claim 25, further comprising a sales information input module for receiving and storing information on total sales during the predetermined time periods, and a report generator which generates reports comparing total sales during each time period to the traffic count for that time period.

32. A method of managing surveillance through an on-line portal website over a public network, comprising:
receiving and storing device access data associated with a plurality of building surveillance devices at different locations in a data storage module at an on-line portal website, the access data including the internet protocol (IP) address, user login information, and onboard application programming information for each surveillance device, at least some of the surveillance devices having different onboard application programming from other surveillance devices;
communicating with the surveillance devices using the stored device access data and controlling the devices to send surveillance data to the website on a selected schedule;
storing surveillance data received from surveillance devices in an archive data storage module at the website; and
displaying data from one or more selected surveillance devices on a customized user interface on request by a user connected to the website, the data being selected from the group consisting of live data received at the website from one surveillance device, multi-view live data received at the website from any selected group of surveillance devices, stored archive data for a selected time period from one surveillance device, and multi-view archive data received at the website from any selected group of surveillance devices, the multi-view live and archive data comprising a simultaneous display on the interface of data from the selected surveillance devices.

33. The method of claim 30, further comprising providing a control option to users at the customized user interface whereby users control selected operational characteristics of associated surveillance devices through the website.

34. The method of claim 30, further comprising periodically checking the operational status of each device from the website, receiving and storing device status information from registered devices, and notifying the user associated with a device if a device malfunction is detected.
